(19) United States
(12) Patent Application Publication
(10) Pub. No.: US 2003/0179693 A1
(43) Pub. Date: Sep. 25, 2003

(54) Single-sided double layer optical disc, and method and apparatus for manufacturing the same

(75) Inventor: Yasuaki Ootera, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/357,421

(22) Filed: Feb. 4, 2003

(30) Foreign Application Priority Data
Mar. 22, 2002 (JP) 2002-081794

(51) Int. Cl. B29D 17/00

(52) U.S. Cl. 369/283; 264/1.33; 264/1.38; 264/1.7; 264/2.1; 425/174.4

(57) ABSTRACT

A stamper is spin-coated with a 2P resin. A molded substrate having a first recording layer formed thereon is spin-coated with a UV curing adhesive agent. The molded substrate spin-coated with the UV curing adhesive agent and the stamper spin-coated with the 2P resin are pressed and stuck to each other in vacuum and irradiated with UV to harden the adhesive layer and the 2P resin layer. The stamper is peeled off, a second recording layer is formed on the 2P resin layer, and a cover layer is formed on the second recording layer.

### CROSS-REFERENCE TO RELATED APPLICATIONS

This application is based upon and claims the benefit of priority from the prior Japanese Patent Application No. 2002-081794, filed Mar. 22, 2002, the entire contents of which are incorporated herein by reference.

### BACKGROUND OF THE INVENTION

1. Field of the Invention

The present invention relates to a method for manufacturing a single-sided double layer optical disc having two recording layers which are irradiated with a light beam from one side of the disc to record and reproduce or to only reproduce information.

2. Description of the Related Art

A next-generation optical disc is expected to be mostly of a surface recording type having a thin cover layer provided therein in order to improve a recording density by increasing an NA value. To further increase a capacity of this optical disc, available is such means as to provide a single-sided double layer construction of a disc. To provide the single-sided double layer construction of the next-generation disc, there may be a method available to manufacture a disc by using a resin (2P resin: Photo-Polymer) which hardens when irradiated with ultraviolet (UV). This method has been developed in order to solve a problem of a difficulty encountered in conventionally transferring an information pit to a thin cover layer by injection-molding. Such an optical disc manufacturing method is disclosed in, for example, Jpn. Pat. Appln. KOKAI Publication No. 10-283682.

This manufacturing method is explained in brief as follows: First, on a molded substrate having a Layer 1 (L1) formed thereon, a UV curing adhesive agent is applied and hardened. Then, the molded substrate and a stamper are stuck to each other via a 2P resin by a spin-coating treatment, UV is applied to harden the 2P resin, and the stamper is peeled off. On an exposed pattern of the 2P resin, a Layer 0 (L0) is formed, to which is in turn stuck a cover layer, thus completing a single-sided double layer disc.

In the above-mentioned conventional technique, a stamper is stuck via a 2P resin on an adhesive layer made of a UV curing adhesive agent. In this case, the adhesive layer and the 2P layer are superposed on each other to form an intermediate layer, specifically by spin-coating the adhesive layer having adhesive properties with the 2P resin, so that there inevitably occurs a problem that the intermediate layer cannot obtain high uniformity in thickness. The more non-uniform the thickness of the intermediate layer is, the more difficult the focusing and tracking by means of optical pick-up for recording/reproduction of information on the disc becomes.

### BRIEF SUMMARY OF THE INVENTION

In view of the above, it is an object of the present invention to provide a next-generation single-sided double layer optical disc which has improved uniformity in thickness of an intermediate layer provided between two recording layers.

To this end, according to one embodiment of the present invention, a molded substrate having an L1 layer formed thereon and a stamper having an L0 layer pattern formed thereon are spin-coated with a UV curing adhesive agent and a 2P resin respectively and then stuck to each other in vacuum in a condition where their sides spin-coated with these agent and resin respectively face each other. Thus, it is possible to avoid non-uniformity in thickness of the intermediate layer which is brought about by spin-coating the adhesive layer having adhesive properties with the 2P resin.

It is only necessary that a UV curing adhesive agent and a 2P resin are applied onto the molded substrate and the stamper, respectively, to stick them on each other, and hence, a relevant apparatus can be simplified as compared to a case of stacking the adhesive layer and the 2P resin sequentially on the molded substrate, which makes it possible to reduce a time for manufacturing each of the discs, that is, a tact time.

Furthermore, a conventional method of sticking the molded substrate and the stamper to each other by a spin-coating treatment in a condition where a 2P resin is sandwiched therebetween has had large irregularities in thickness of the intermediate layer because of the warping and poor thickness accuracy of the molded substrate and the stamper. This disadvantage, however, can be avoided by the method of the present invention of performing the spin-coating treatment on the molded substrate and the stamper independently of each other and, finally, sticking them to each other.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a partial cross-sectional view for outlining a configuration of a next-generation double layer DVD;

FIG. 2 is a partially expanded cross-sectional view for showing a construction of a phase-change type single-sided double layer disc;

FIG. 3 is an illustration for showing one example of a flow diagram of a typical method of manufacturing the next-generation double layer disc;

FIG. 4 is a flowchart for showing a method for manufacturing the next-generation double layer disc according to one embodiment of the present invention;

FIG. 5 is a flow diagram for showing the method for manufacturing the next-generation double layer disc according to the one embodiment of the present invention; and

FIGS. 6A and 6B are cross-sectional views for showing a double layer disc manufactured by a conventional method and that manufactured by the method of the present invention respectively.

### DETAILED DESCRIPTION OF THE INVENTION

The following description is given by way of example of embodiments of the present invention but not limitation on an apparatus and a method thereof. Although the following will mainly describe a case where the present invention is applied to an optical disc capable of rewriting such as a DVD-RAM or DVD-RW, the present invention is applicable also to a read-only disc such as a DVD-ROM or to a one-time writable disc such as a DVD-R.

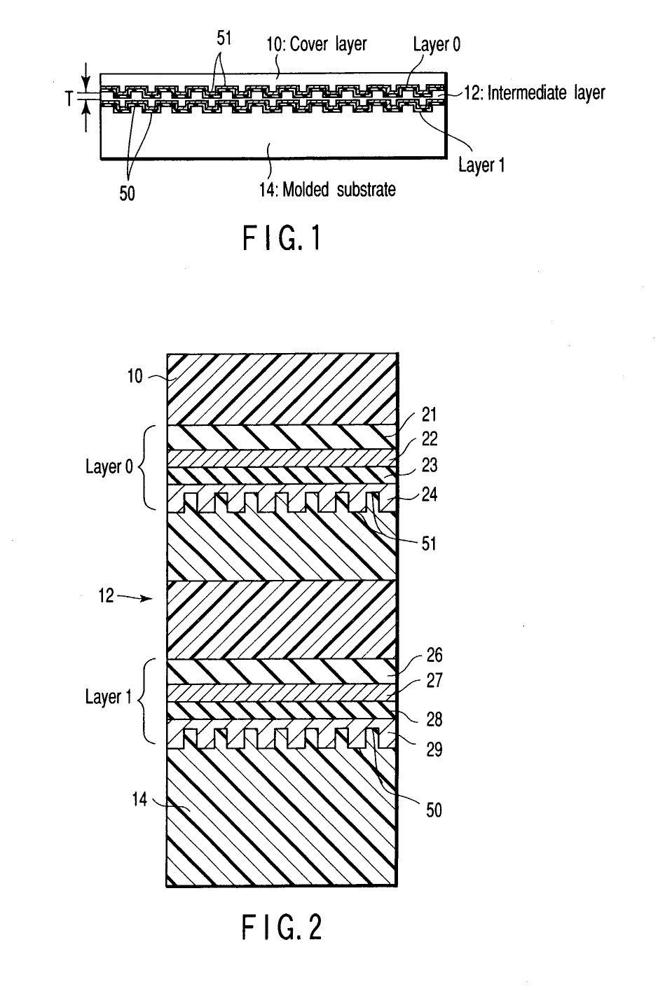

FIG. 1 is a partial cross-sectional view outlining a configuration of a next-generation double layer DVD.

On an upper face of a molded substrate 14 is there formed a land/group 50 corresponding to a recording track in a spiral manner as viewed from the above. On the molded substrate 14 are there formed a Layer 1 and a Layer 0 in this order as a recording layer with an intermediate layer 12 as sandwiched therebetween. Also on an upper face of the intermediate layer 12 is there formed a land/group 51 in a spiral manner as viewed from the above. The upper surface of the Layer is protected by a cover layer 10. Note here that in the case of a read-only DVD-ROM, no land/group is formed, but an information pit (recess) is formed instead.

The molded substrate 14 is typically made of a resin such as poly-carbonate. These two recording layers are each irradiated with a light beam through the thin cover layer 10 (having a thickness of 0.1 mm or so), to perform recording or reproduction. The disc has a CD/DVD size of, for example, a diameter of 120 mm, an inner diameter of 15 mm, and a thickness of 1.2 mm. Preferably a recording/reproduction optical system employs a light beam having a wavelength of 405 nm and an objective lens having an NA value of 0.85, as well as a thickness T of the intermediate layer 12 of about 25±2 μM so that both layers may be free of an aberration nor inter-layer cross-talk in recording/reproduction.

FIG. 2 is a partially expanded cross-sectional view for showing a construction of a phase-change type single-sided double layer disc.

Although a plurality of thin films such as a reflection film are stacked one on another as having irregularities in accordance with the shapes of the land/groups 50 and 51 formed on the surface of the substrate 14 and the intermediate layer 12 respectively, they are shown just as a plurality of flat layers (21, 22, 23, and 24) and another plurality of flat layers (26, 27, 28, and 29) in FIG. 2 to simplify explanation.

In FIG. 2, the substrate 14 is manufactured by injection molding as in the case of an ordinary optical disc and has the land/group 50 formed thereon. The thickness of the molded substrate 14 may be of any value as far as it is enough to provide mechanical strength. On such a face of this disc substrate as to have the land/group 50 formed thereon is there formed the Layer 1 (phase-change recording medium) capable of recording/reproduction/erasure. A reference numeral 26 indicates a dielectric protection film made up of a composite film of ZnS.SiO₂ and a reference numeral 27, a phase-change recording film made up of a three-element alloy of GeSbTe. Furthermore, on these films are there formed the ZnS.SiO₂ dielectric protection film 28 and the AgPtCu reflection film 29 in this order.

Onto the Layer 1 is there adhered the intermediate layer 12, while on one such side of the intermediate layer 12 as to face the right surface is there formed the land/group 51. On this land/group 51 is there formed the Layer 0 made of another phase-change medium capable of recording/reproduction/erasure. That is, the dielectric protection film 21 made of ZnS.SiO₂, the phase-change recording film 22 made of three-element alloy GeSnTe, the dielectric protection film 23 made of ZnS.SiO₂, and the semi-transparent film 24 made of Au etc. are stacked in this order. On this dielectric protection film 21 is there formed the surface cover layer 10 made of a UV resin.

The above description has been made on a DVD-RAM or a DVD-RW. In the case of a DVD-R, the recording layer is made of pigment, whereby the reflectivity of a portion irradiated with laser light for writing is changed permanently. In the case of a read-only DVD-ROM, there is formed no land/group nor recording layer subject to a change in phase upon laser beam application, hut an information pit and a reflection layer serving as an information recording layer are formed instead as mentioned above.

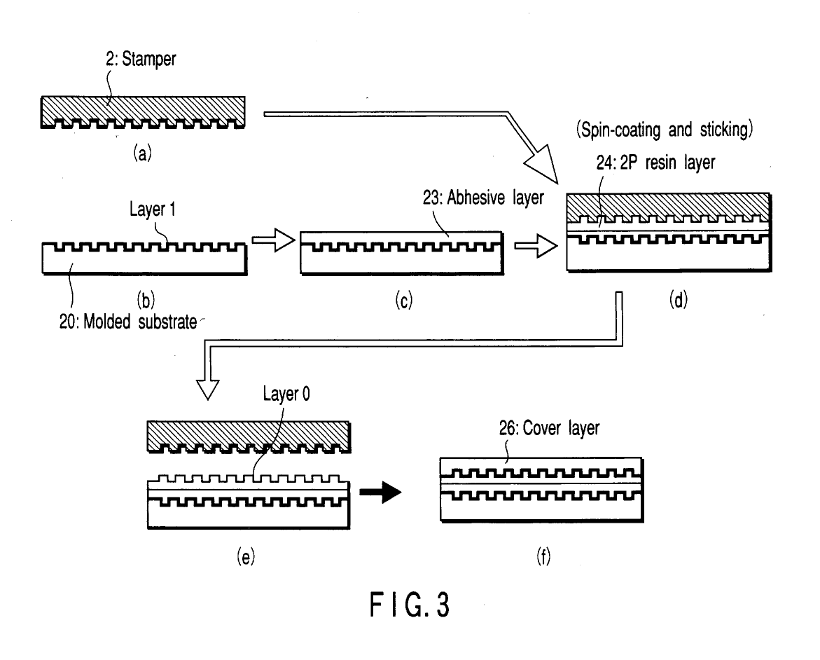

A typical process for manufacturing such a double layer disc is described as follows. FIG. 3 is one example of a flow diagram for showing a typical method of manufacturing the next-generation double layer disc. First, a substrate having a pattern of a Layer 1 transferred thereto is manufactured by injection molding. Then, as shown at (b) in FIG. 3, on a pattern of a molded substrate 20, a total reflection film is formed by sputtering etc., on which is further formed the Layer 1 of a recording film in the case of a disc capable of rewriting such as shown in FIG. 2. The Layer 1 thus provided is spin-coated with a UV curing adhesive agent, to form an adhesive layer 23 as shown at (c) in FIG. 3. This adhesive layer 23 is thus formed to improve adhesive force between the molded substrate and a 2P (Photo-Polymer) resin layer to be formed subsequently.

Next, as shown at (d) in FIG. 3, a 2P resin is dripped onto the adhesive layer 23 and sandwiched between this adhesive layer 23 and a stamper 2 of (a) in FIG. 3 stamped with a pattern of a Layer 0. Then, this structure is spun to spin off an extra portion of this 2P resin, thus transferring the pattern. Then, as shown at (e) in FIG. 3, the stamper 2 is peeled off to form the Layer 0 and, finally, a cover layer 26 is formed to complete a product as shown at (f) in FIG. 3. This is the typical method for manufacturing the next-generation double layer disc.

By this method, however, when an adhesive layer is spin-coated with a 2P resin layer, the 2P resin layer cannot uniformly be applied because of adhesive properties of an adhesive agent used, thus resulting in irregularities in thickness of an intermediate layer finally. Moreover, since the 2P resin layer and the adhesive layer are sandwiched between the molded substrate 20 and the stamper 2 during the spin-coating treatment, the warping or thickness irregularities of the molded substrate 20 and the stamper 2 are reflected directly on irregularities in thickness of the intermediate layer. In addition, since the adhesive layer and the 2P resin layer are stacked on the molded substrate, the tact time cannot be reduced, thus resulting in poor productivity.

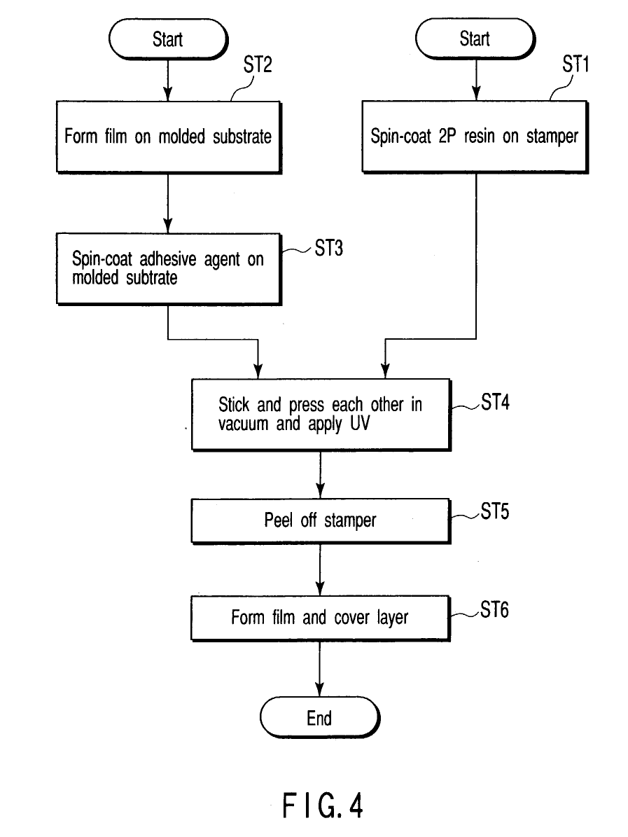

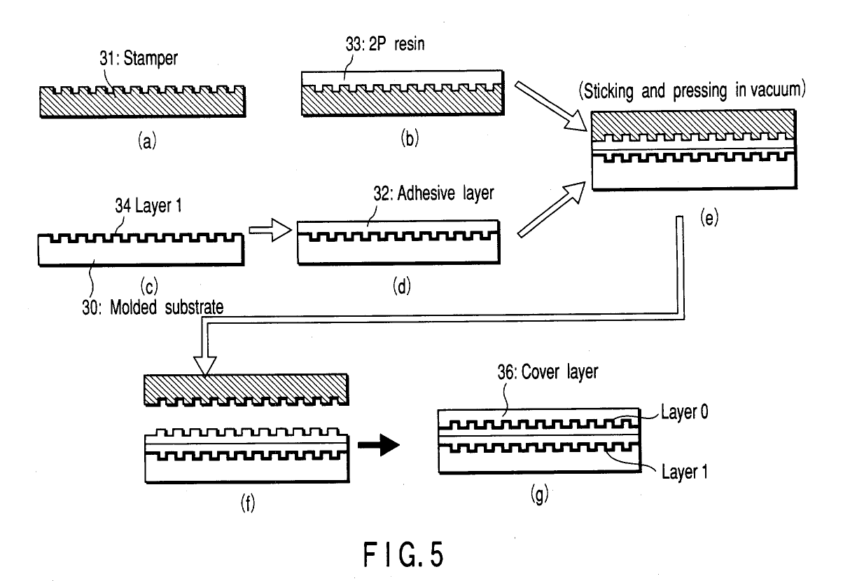

Therefore, the present invention provides a new next-generation double layer disc manufacturing method. FIG. 4 is a flowchart for showing the method for manufacturing the next-generation double layer disc according to the present invention and FIG. 5, a flow diagram thereof.

First, as shown at (a) and (b) in FIG. 5, a stamper (which is generally made of metal) having a pattern of a Layer 0 thereon is spin-coated with a 2P resin (ST1). Concurrently, as shown at (c) in FIG. 5, a film is formed on a molded substrate (which is generally made of poly-carbonate) having a pattern of a Layer 1 transferred thereto (ST2), to which is applied a UV curing adhesive agent 32 by the spin-coating treatment as shown at (d) in FIG. 5 (ST3). Next, as shown at (e) in FIG. 5, the stamper and the molded substrate are stuck and pressed to each other in vacuum (ST4). They are done so in vacuum in order to remove air bubbles generated in a 2P resin 33 and the adhesive agent 32 and, furthermore, to prevent the air bubbles from entering a sticking face (that is, an interface between the 2P resin 33 and the adhesive agent 32).

Then, this structure is irradiated with UV to be hardened, from which structure the stamper is peeled off as shown at (f) in FIG. 5 (ST5). As shown at (g) in FIG. 5, a film is formed on an exposed surface of the 2P resin to form a cover layer, thus completing a next-generation double layer disc (ST6).

It is to be noted that the UV curing adhesive agent 32 may be an acrylic-based or epoxy-based resin, the 2P resin 33 may be an acrylic-based or urethane-based resin, and the material of the stamper 31 may be nickel, silver, aluminum, gold, etc. In the case of the present embodiment, materials of these resins and the stamper are selected so that adhesive force of the 2P resin 33 to the stamper 31 may be 1/10 or less of that of the UV curing adhesive agent 32 to the molded substrate 30. By thus setting the adhesive force, when the stamper is peeled off, the 2P resin 33 can be released from the stamper without being peeled off from the molded substrate 30.

Furthermore, an optical disc manufacturing apparatus implementing the present embodiment has processing sections which respectively correspond to the steps shown as blocks in FIG. 4. The description of these processing sections is the same as that of the steps described above, and so it is omitted.

By the present invention, a spin-coating treatment is performed on a stamper and a molded substrate which have good wettability (affinity) for a resin, so that the thickness of a resultant resin layer has less irregularities and an improved accuracy. The irregularities in layer thickness are essentially ±3 μm or less throughout the disc. Therefore, a laser beam spot by means of optical pick-up can be generated on the Layer 1 or 0 stably, thus improving recording or reproduction characteristics. Furthermore, by the present invention, the spin-coating treatment is not performed in a condition where a resin is sandwiched between the stamper and the molded substrate, so that irregularities in thickness of the intermediate layer are not influenced by the warping or thickness irregularities of the molded substrate and the stamper. In addition, by the present invention, it is necessary only to simultaneously apply an adhesive agent and a resin to the molded substrate and the stamper respectively, stick them to each other, and harden them once, thus enabling reducing the tact time. Furthermore, the present invention does not have such a spin-coating step as shown at (d) in FIG. 3 which complicates the structure of the manufacturing apparatus, thus enabling reducing the costs of facilities.

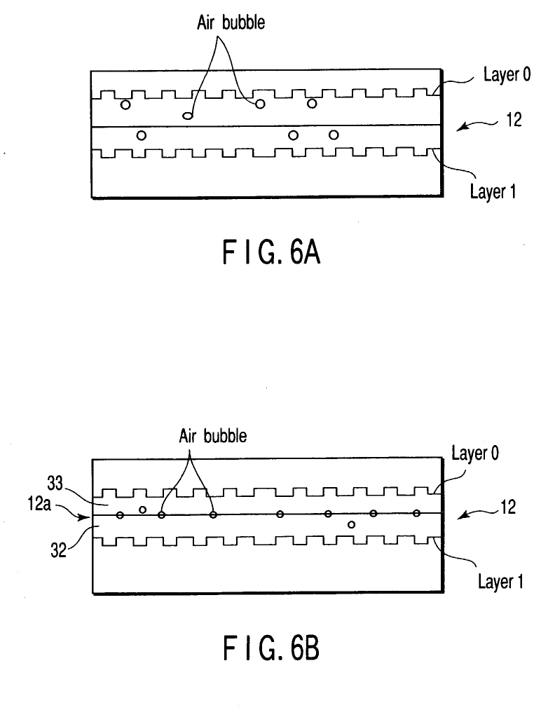

FIG. 6A shows a cross-sectional views of a double layer disc manufactured by such a conventional method as shown in FIG. 3. If a double layer disc is manufactured by such a conventional method, the air bubbles may generate in the intermediate layer 12 interposed between the Layers 0 and 1. If the air bubbles are generated in the vicinity of the Layer 0 or 1, they affect the recording laser beam, which makes the recording impossible in the vicinity of the air bubbles.

FIG. 6B is a cross-sectional view of a double layer disc manufactured by the method of the present invention shown in FIGS. 4 and 5. By the present invention, a sticking operation such as shown at (e) in FIG. 5 can be performed easily in vacuum, so that air bubbles are less liable to remain in the intermediate layer 12 and, if any, are concentrated to an interface 12a in the intermediate layer 12 (which is comprised of the 2P resin layer 33 and the adhesive agent layer 32). Specifically, at least about 90% of the air bubbles generated in the intermediate layer 12 are concentrated to the interface 12a. That is, according to the method of the present invention, as compared to a case of the conventional method, the air bubbles are extremely less generated in the vicinity of the Layer 1 or 0, which can improve a yield of the optical discs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A single-sided double layer optical disc manufacturing method comprising:
spin-coating a molded substrate having a first layer formed thereon with a UV curing adhesive agent;
spin-coating a stamper with a UV curing resin;
mutually sticking, in vacuum, the molded substrate spin-coated with the UV curing adhesive agent and the stamper spin-coated with the UV curing resin;
curing the adhesive layer and the UV curing resin layer with UV; and
peeling off the stamper, forming a second layer on the UV curing resin layer, and then forming a cover layer on the second layer.

2. The optical disc manufacturing method according to claim 1, wherein spin-coating the molded substrate with the UV curing adhesive agent and spin-coating the stamper with the UV curing resin are performed essentially simultaneously.

3. The optical disc manufacturing method according to claim 1, wherein materials of the UV curing resin, the UV curing adhesive agent and the stamper are selected so that adhesive force of the UV curing resin to the stamper may be 1/10 or less of adhesive force of the UV curing adhesive agent to the molded substrate.

4. The optical disc manufacturing method according to claim 2, wherein materials of the UV curing resin, the UV curing adhesive agent and the stamper are selected so that adhesive force of the UV curing resin to the stamper may be 1/10 or less of adhesive force of the UV curing adhesive agent to the molded substrate.

5. A single-sided double layer optical disc manufacturing apparatus comprising:
a first spin-coating section which spin-coats a molded substrate having a first layer formed thereon with a UV curing adhesive agent;
a second spin-coating section spin-coating a stamper with a UV curing resin;
a sticking section mutually sticking and pressing, in vacuum, the molded substrate spin-coated with the UV curing adhesive agent by the first spin-coating section and the stamper spin-coated with the UV curing resin by the second spin-coating section;
a curing section applying UV to the adhesive layer and the UV curing resin layer mutually stuck by the sticking section to cure them; and
a forming section which peels off the stamper from the UV curing resin layer cured by the curing section, forms a second layer on the UV curing resin layer, and then forms a cover layer on the second layer.

6. A single-sided double layer optical disc, wherein air bubbles generated in an intermediate layer formed between two recording layers are concentrated in the vicinity of an interface formed in the intermediate layer.
